(19) United States
(12) Patent Application Publication
(10) Pub. No.: US 2019/0376652 A1
(43) Pub. Date: Dec. 12, 2019

(54) Photo Luminescent Lighting Device

(71) Applicant: Alliance Sports Group, L.P., Fort Worth, TX (US)

(72) Inventors: Todd L. Marcucci, Mansfield, TX (US); Gregory Lee Horne, Euless, TX (US)

(21) Appl. No.: 16/438,934

(22) Filed: Jun. 12, 2019

Related U.S. Application Data
(60) Provisional application No. 62/683,814, filed on Jun. 12, 2018.

(51) Int. Cl. F21K 9/64; C09K 11/02; C09K 11/77; C09K 11/08

(52) U.S. Cl. CPC F21K 9/64; C09K 11/02; F21Y 2115/10; C09K 11/7706; C09K 11/0838; C09K 11/7721

(57) ABSTRACT

A hand held light having a light assembly is disclosed having a substrate carrying a light emitting element. A phosphor layer is disposed atop the substrate and light emitting element. A photoluminescent layer is disposed atop the phosphor layer.

### PRIORITY CLAIM

This application claims priority to U.S. Ser. No. 62/683,814 filed on Jun. 12, 2018 entitled “Photo Luminescent Lighting Device” which is incorporated herein by reference in its entirety.

### FIELD OF THE TECHNOLOGY

The current application relates to lighting devices. More particularly, the current application is directed to an improved apparatus for providing luminescent and photoluminescent lighting.

### BACKGROUND

Solid state devices, such as light emitting diodes (LED)s, are attractive candidates for replacing conventional light sources such as incandescent and fluorescent lamps.

LEDs have substantially higher light conversion efficiencies than incandescent lamps and longer lifetimes than both types of conventional light sources. In addition, some types of LEDs now have higher conversion efficiencies than fluorescent light sources and still higher conversion efficiencies have been demonstrated in the laboratory. Finally, LEDs require lower voltages than fluorescent lamps, and therefore, provide various power saving benefits.

To replace conventional lighting systems, LED-based sources that produce white light are desired. One way to produce white light is to deposit a phosphor material on the LEDs, such that monochromatic light emitted from blue or UV LEDs is converted to broad-spectrum white light. The phosphor material may be formed by mixing a phosphor powder into a polymer such as silicone at a pre-defined concentration, or with a pre-defined mixture, resulting in a suspension of phosphor particles in the silicone. This mixture is then deposited onto the LED at a pre-defined volume and/or weight, and subsequently subjected to a curing procedure. The resulting phosphor-coated LEDs are then tested and put into different color bins according to the actual tested color. There is a need to improve the variability and type of light emitted from coated LEDs in lighting devices.

### BRIEF DESCRIPTION OF THE DRAWINGS

The present technology will become more fully apparent from the following description and appended claims, taken in conjunction with the accompanying drawings. Understanding that these drawings merely depict examples of the present technology they are, therefore, not to be considered limiting of its scope. It will be readily appreciated that the components of the present technology, as generally described and illustrated in the figures herein, could be arranged and designed in a wide variety of different configurations. Nonetheless, the invention will be described and explained with additional specificity and detail through the use of the accompanying drawings in which:

FIG. 1 is a cross section of a lighting device in accordance with one aspect of the technology;

FIG. 2a is a cross section of a lighting device in accordance with one aspect of the technology;

FIG. 2b is a cross section of a lighting device in accordance with one aspect of the technology;

FIG. 3 is a cross section of a lighting device in accordance with one aspect of the technology;

FIG. 4 is a cross section of a lighting device in accordance with one aspect of the technology;

FIG. 5a is a cross section of a lighting device in accordance with one aspect of the technology;

FIG. 5b is a cross section of a lighting device in accordance with one aspect of the technology;

FIG. 6 is a top view of a lighting device in accordance with one aspect of the technology;

FIG. 7 is a top view of a lighting device in accordance with one aspect of the technology;

FIG. 8 is a top view of a lighting device in accordance with one aspect of the technology;

FIG. 9 is a top view of a lighting device in accordance with one aspect of the technology; and

FIG. 10 is a top view of a fixture with a plurality of lighting devices in accordance with one aspect of the technology.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

As used herein, “excitation” refers to the phenomenon wherein the incident radiation excites a molecule from a lower energy state to a higher energy state.

As used herein, “luminescence” is defined as emission of electromagnetic radiation.

As used herein, “photoluminescence” is luminescence occurring as a consequence of excitation by electromagnetic radiation including fluorescence and phosphorescence.

As used herein, “fluorescence” is emission of electromagnetic radiation from singlet excited states in which the electron in the excited orbital is paired (of opposite sign) to the second electron in the ground state orbital, and wherein the return to the ground state is spin allowed and occurs rapidly by emission of a photon and wherein the emission rates are typically 10-8s-1 with a typical lifetime of around 10 nanoseconds.

“Phosphorescence” is emission of electromagnetic radiation from triplet excited states, in which the electron in the excited orbital has the same spin orientation as the ground state electron.

As used herein, “luminescent materials” are those that exhibit “luminescence.” “Photoluminescent materials” are those that exhibit luminance as a consequence of excitation by electromagnetic radiation. “Photoluminescent fluorescent” materials are those which upon excitation by electromagnetic radiation exhibit fluorescence.

As used herein, “photoluminescent phosphorescent” materials are those which upon excitation by electromagnetic radiation exhibit phosphorescence.

As used herein, “pigment” is a material in a solid particulate form which is substantially insoluble in a liquid carrier medium chosen to carry such materials, but which can be mechanically distributed in the liquid carrier medium to modify its color and/or electromagnetic radiation-scattering properties.

“Fluid carrier medium” is a liquid or gel that acts as a carrier for materials distributed in a solid state and/or dissolved therein.

As used herein, a “formulation” is a fluid carrier medium, as defined above, comprising at least one material either dissolved and/or distributed in a solid state within said liquid carrier medium.

As used herein, a “photoluminescent fluorescent formulation” is a formulation, as defined above, which additionally comprises materials exhibiting fluorescence that are either distributed in a solid state in said formulation or are dissolved in said formulation.

As used herein, a “photoluminescent phosphorescent formulation” is a formulation, as defined above, which additionally comprise materials exhibiting phosphorescence that are distributed in a solid state in said formulation.

As used herein, a “photoluminescent formulation” is a formulation, as defined above, which additionally comprises either photoluminescent phosphorescent materials as defined above, or photoluminescent fluorescent materials as defined above, or both.

As used herein, a “photoluminescent phosphorescent film” is a film resulting from at least one photoluminescent phosphorescent formulation that is substantially dry as characterized by the residual liquid carrier medium being in the range of 1-5 weight % of the total weight of the film.

As used herein, a “photoluminescent fluorescent film” is a film resulting from at least one photoluminescent fluorescent formulation that is substantially dry, as characterized by the residual liquid carrier medium being in the range of 1-5 weight % of the total weight of the film.

As used herein, a “photoluminescent film” is a film resulting from either a photoluminescent fluorescent, or photoluminescent phosphorescent formulation, or both, that is substantially dry, as characterized by the residual liquid carrier medium being in the range of 1-5 weight % of the total weight of the film.

As used herein, “visible electromagnetic radiation” is characterized by electromagnetic radiation with wavelengths in the region of 400 nanometers (“nm”) to 700 nm.

### Example Embodiments

An initial overview of technology embodiments is provided below and specific technology embodiments are then described in further detail. This initial summary is intended to aid readers in understanding the technology more quickly, but is not intended to identify key or essential features of the technology, nor is it intended to limit the scope of the claimed subject matter.

Broadly speaking, with general reference to FIGS. 1-5, aspects of the current technology operate to provide luminescent and photoluminescent properties to a flashlight or other lighting device or lighting assembly 5 that can be incorporated into a flashlight, headlamp, lantern, or other light utility. A light emitting element 10 emits a light spectrum (either visible electromagnetic radiation or other spectrums), where the light emitting element is a light emitting diode (LED), an electronic gun, an organic light emitting diode (OLED), chip-on board light emitting diode (COB LED), or a general light source. A phosphor layer 20 is formed on the light emitting element 10 to adjust a light color of the light emitting element, where the phosphor layer 20 has a flat surface, an arcuate surface, or any other geometric surface. In one aspect of the technology, the phosphor layer 20 is formed on the light emitting element 10 through a wet coating or a dry deposition. The phosphor layer 20 has a phosphor powder combination obtained by a mixture under a dose composition ratio, where a wavelength emitted from the light emitting element 10 is changed by mixing colors of micro-lights emitted from crystal grains of the phosphor powder combination.

In one aspect of the technology, the phosphor layer 20 comprises a mixture of phosphor powder and a transparent medium or fluid carrier medium such as silicon, silicon oxide, titanium oxide or an epoxy resin. In one aspect, the phosphor powder combination is Ce (cerium): LiAlO2 (lithium aluminum oxide) which has a dose composition ratio ranging from 0.0001 percent (%) to 5% by mass and is mixed in the transparent medium to form the phosphor layer 20. The phosphor powder emits lights of three primary colors: red, blue and green. The phosphor layer 20 emits the desired light spectrum, such as an ultra violet light, a blue light, a white light or other light source, through mixing colors of micro-lights emitted from crystal grains of the phosphor powder combination with a light spectrum provided by the light emitting element 10. In one aspect, the phosphor layer 20 is configured to convert light emitted from element 10 (e.g., blue light) into white light through mixing of particles that emit red, blue, and green wavelengths of light.

During the wet coating, the phosphor powder and the transparent medium are directly weighted to be added in a proper solvent for an even mixture; or, the phosphor powder and the transparent medium are mixed under an atomic state in a solution through a sol-gel method or a co-precipitation method to be added in the solvent. Then the mixture is coated on the light emitting element 10 through spin-coating or print-coating for obtaining a light spectrum excited by a light. During the dry deposition, the phosphor powder and the transparent medium are directly weighted to obtain a target; or, the phosphor powder and the transparent medium are mixed under an atomic state in a solution through a sol-gel method or a co-precipitation method to obtain a target. Then the target is deposited on the light emitting element 10 through evaporation, sputtering or ion-beam deposition for obtaining a light spectrum excited by a light.

In one aspect of the technology, the phosphor layer 20 comprises a film. The wavelength distribution of a conventional white LED used in a lighting device of a liquid crystal display device, for example, spreads broadly, with peaks at 450 nm and 580 nm. The wavelengths peak within this range generally because light emitted by the white LED is white light of a mixed color obtained by mixing blue color light and green color light. In contrast, peaks of wavelength selected by a color filter used in a liquid crystal display device or the like are, generally speaking, 450 nm for blue, 530 nm for green, and 600 nm for red. Meaning, for light emitted from a white light source, wavelengths of 480 nm to 510 nm and 570 nm to 590 nm are cut; the light having the wavelengths cut is absorbed by the color filter.

In a phosphor film according to one aspect of the technology, a phosphor layer 20 applied with phosphor particles mixed in a binder and formed on a translucent film base material wherein the surface of the phosphor layer is coated with a non-permeable layer. The non-permeable layer is made of the non-water-permeable material, such as silicone, minimizing contact between the phosphor layer 20 and moisture. According to one aspect of the technology, the phosphor layer 20 comprises phosphor film in which a phosphor layer 20 receives phosphor particles mixed in a binder formed on a translucent base material. In the phosphor particles, a wavelength absorbed by the color filter is an excitation wavelength. A luminance wavelength of the phosphor particles belongs to a region of wavelengths transmitted by the color filter. When the translucent film is thin, it is possible to isolate the phosphor layer 20 from moisture in the environment by forming the translucent film itself from a non-permeable material or forming a second non-permeable layer on the translucent film, applying a phosphor layer 20 over the second non-permeable layer, and further coating the phosphor layer 20 with a first non-permeable layer. Advantageously, this arrangement maintains characteristics of the phosphor particles over a longer period of time. A phosphor film is generally described herein, but it is understood that different aspects of the technology include photoluminescent films including photoluminescent phosphorescent films and photoluminescent florescent films.

In one aspect of the technology, the lighting device 10 comprises a specific phosphor layer 20 as well as a more general photoluminescent layer 40. As used herein the term “phosphor layer” is defined as a mixture of phosphor powder with a carrier that is used in connection with a light emitting element 10 to create an emission of light, including a mixture of red, green, and blue light to form a “white light” emission. The photoluminescent layer 40 is an additional layer used in connection with the lighting element 10 as further described herein to further enhance the light emissions from lighting element 10 that are passing through phosphor layer 20, including, but without limitation, to propagate a second wavelength of light from the same or different light emitting elements 10. The photoluminescent layer 40 has different photoluminescent pigments, formulations, ratios, and/or properties than the phosphor layer 20. Both the photoluminescent layer 40 and the phosphor layer 20 are configured to emit a portion of the light that passes therethrough and attenuate a portion of light that enters the layer. Meaning, all light that is emitted from the lighting element(s) 10 may not pass completely through the respective layer (20 and/or 40). A portion of light propagated or emitted by lighting element(s) 10 will pass through the respective layer (20 and/or 40) and a portion will be attenuated (i.e., will not pass through) by the layer.

In one aspect of the technology, the photoluminescent layer 40 comprises luminescent materials including photoluminescent fluorescent materials and/or photoluminescent phosphorescent materials and can comprise a film such as a photoluminescent phosphorscent film, a photoluminescent fluorescent film, or a photoluminescent film. In one aspect, the photoluminescent layer 40 comprises a photoluminescent fluorescent formulation comprising materials exhibiting fluorescence that are either distributed in a solid state in said formulation or are dissolved in said formulation. In another aspect, the photoluminescent layer 40 comprises a photoluminescent phosphorescent formulation which comprises materials exhibiting phosphorescence that are distributed in a solid state in said formulation or are dissolved in said formulation.

In one aspect of the technology, the photoluminescent layer 40 comprises a photoluminescent powder mixed with a transparent medium such as silicon, silicon oxide, titanium oxide or an epoxy resin. In one aspect of the technology, the photoluminescent layer comprises a mixture of phosphor powder and a transparent medium such as silicon, silicon oxide, titanium oxide or an epoxy resin. In one aspect, the phosphor powder combination is Ce (cerium): LiAlO2 (lithium aluminum oxide) that, when excited, emits lights of three primary colors of red, blue and green having a dose composition ratio of 0.0001% to 5%. The combination is mixed in the transparent medium having a dose ratio that is different than that used for the phosphor layer 20.

In one aspect, the photoluminescent layer 40 emits a desired light spectrum, such as an ultra violet light, a blue light, a white light or other light source, through mixing colors of micro-lights emitted from crystal grains of the phosphor powder combination with a light spectrum provided by the light emitting element 10 having passed through and being modified by, phosphor layer 20. During the wet coating, the phosphor powder, and the transparent medium are directly weighted to be added in a proper solvent for an even mixture; or, the phosphor powder and the transparent medium are mixed under an atomic state in a solution through a sol-gel method or a co-precipitation method to be added in the solvent. The mixture is coated on the light emitting element 10 (e.g., on top of or near phosphor layer 20) through spin-coating or print-coating for obtaining a light spectrum excited by a light. During the dry deposition, the phosphor and the transparent medium are directly weighted to obtain a target; or, the phosphor powder and the transparent medium are mixed under an atomic state in a solution through a sol-gel method or a co-precipitation method to obtain a target. Then the target is deposited on the light emitting element 10 through evaporation, sputtering or ion-beam deposition for obtaining a light spectrum excited by a light. In other words, the photoluminescent layer 40 may be applied generally to the lighting element 10 and/or on top of the phosphor layer 20 in the same way that the phosphor layer 20 is applied to lighting element 10 (i.e., wet coating, dry deposition, etc.). In aspects where the phosphor layer 20 is a wet coating, the layer 20 ranges between 0.1 and 0.2 inches. In aspects where the phosphor layer is a dry film deposition, the layer 20 ranges from between 0.02 to 0.05 inches.

In one aspect of the technology, a compound comprising YAG (Yttrium Aluminum Garnet) may be used as part of the phosphor powder in the phosphor layer 20 and/or photoluminescent layer 40, including, but without limitation, additional lead and/or Strontium Aluminate (SrAl2O4) compounds. In one aspect of the technology, the photoluminescent layer 40 comprises approximately 50% by volume YAG (or a similar compound) and SrAl2O4 (or similar phosphorescent compounds like SrAl2O4:Eu2+, SrAl4O7, SrAl2O19, Sr0.95Ce0.05Mg0.05Al11.95O19). In some aspects, the YAG and Sr-based component of the phosphorescent compound is less than approximately 50% by volume and in some aspects, it is greater than 50% by volume. Other phosphor powder formulations may also be used in both the phosphor layer 20 and the photoluminescent layer 40. Variations of Cerium doped YAG compounds are also contemplated for use including Y3A15012:Ce3+ or Y3A14GaO12:Ce3+YAG:Ce. Some aspects of the technology employ other dopings utilizing Terbium (YAG:Tb) and Dysprosium (YAG:Dy) to alter the color temperature of the conversion of light as it passes through any particular layer. Additional compounds can include Manganese activated Magnesium Flouro-germanate (Mg4FGeO6:Mn) and Europium activated Barium Manganese Aluminate (BaMg2Al10O7:Eu) and (Lu1-a-b-cYaTbbAc)3(Al1-dBd)5(O1-eCe)12:Ce, Eu, where A is selected from the group consisting of Mg, Sr, Ca, and Ba; B is selected from the group consisting of Ga and In; C is selected from the group consisting of F, Cl, and Br; 0≤a≤1; 0≤b≤1; 0<c≤0.5; 0d≤1; and 0<e≤0.2.

In one aspect of the technology, the photoluminescent layer 40 may comprise a film. In another aspect of the technology, a single film may be placed over a plurality of different light emitting elements wherein the film has different formulations across the film. Meaning, a portion of the film may be configured to proximate the function of the phosphor layer 20 and a separate portion of the film may be configured to proximate the function of the photoluminescent layer 40. In this manner, the single film is applied over a single substrate having a plurality of light emitting elements thereon but having the different lights corresponding to the different portions of the film have different emission properties.

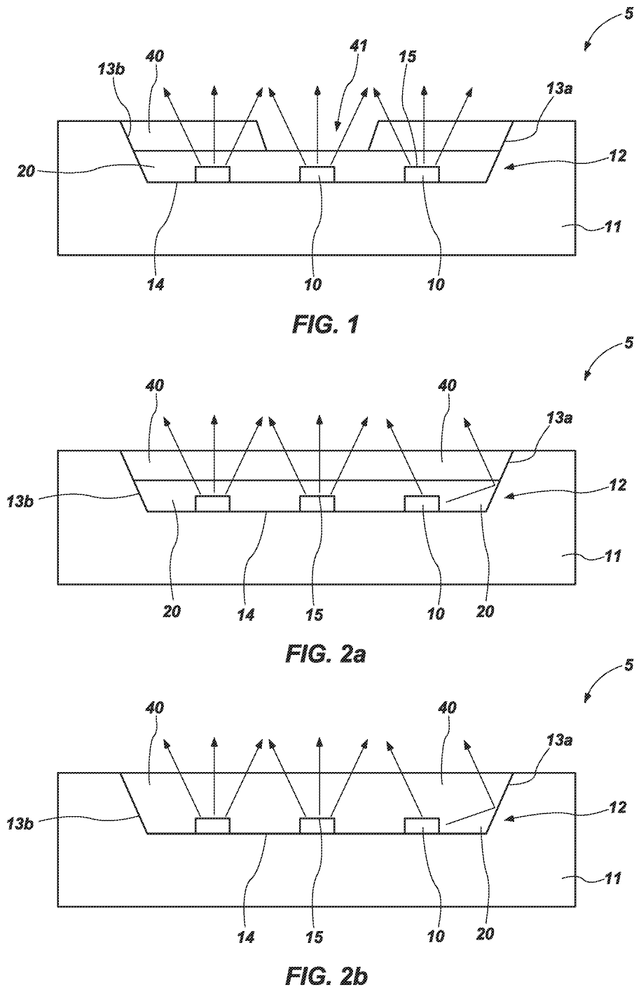

With reference to FIGS. 1-2b, in accordance with one aspect of the technology, a lighting device or lighting assembly 5 is shown comprising a light emitting element 10 disposed on a substrate 11. The light assembly 5 may be a stand-alone light emitting device or may be incorporated into a hand held flashlight, lantern, headlamp, or other utility lighting device. The lighting element 10 and substrate 11 are coupled to a power source that provides electrical power to lighting element(s) 10. In one aspect of the technology, the substrate 11 comprises a chamber 12 on a top side of the substrate 11 that houses the lighting elements 10 between sidewalls 13a and 13b. A phosphor layer 20 is disposed about a bottom surface 14 of the chamber 12 and extends above a top surface 15 of lighting elements 10. A photoluminescent layer 40 is disposed above the phosphor layer 20. In one aspect of the technology, the photoluminescent layer 40 fully encapsulates the phosphor layer 20. In this manner, all light emitted from lighting elements 10 passes through both the phosphor layer 20 and the photoluminescent layer 40. However, as shown in FIG. 1, for example, in one aspect of the technology a void 41 is located in the photoluminescent layer 40 allowing a portion of light emitting from one or more of the light emitting elements 10 to be propagated without passing through the layer 40. In this manner, a portion of the light is modified by the phosphor layer 20 and the photoluminescent layer 40 and a portion of the light is modified only by the phosphor layer 20.

As shown in FIG. 2b, in accordance with one aspect of the technology, a single photoluminescent layer 40 is disposed about the light emitting elements 10. In this aspect, the single layer comprises a combination of a phosphor formulation intended to absorb photons emitted by the light emitting elements 10 and emit wavelengths of light in the blue, green, and red wavelengths of light that approximate white light. The single layer also comprises a fluorescent formulation that will emit wavelengths of light different from that of the phosphor formulation and at a different light intensity. For example, in one aspect of the technology, the phosphor formulation comprises 0.0001% to 5% Ce:LiAlO2 and the fluorescent formulation comprises 10 to 15% of BaSiO5:Pb, 55 to 65% of 3Ca3(PO4) 2Ca(FCl)2:Sb, 5 to 10% of MgOMgF2CeO28:Mn and 20 to 25% of (ZnSr)3(PO4)2:Sn. Other volumetric quantities of the different compounds can be used to achieve the desired intensity of the fluorescent effect.

In another aspect of the technology, a single photoluminescent layer 40 is disposed about the light emitting elements 10 where single layer comprises a phosphor and a phosphorescent formulation. The phosphorescent formulation that will emit wavelengths of light different from that of the phosphor formulation and at a different light intensity. For example, in one aspect of the technology, the phosphor formulation comprises 0.0001% to 5% Ce:LiAlO2 and the phosphorscent formulation comprises SrAl2O4 added in a volumetric quantity to achieve the desired intensity of the phosphorescent effect (e.g., 5% to 40% by mass). In this manner, light (e.g., white light or other) may be propagated from the lighting assembly 5 while power is provided to the device 5. When power is shut off, the layer 40 will continue to propagate light at the desired wavelength and intensity. Generally speaking, the phosphor formulation will propagate light while wavelengths of light are being emitted from the light emitting elements 10. Once the light emitting elements cease propagation of light, the phosphor formulation quickly thereafter ceases to propagate light whereas the phosphorescent formulation will continue to propagate light for a longer period of time.

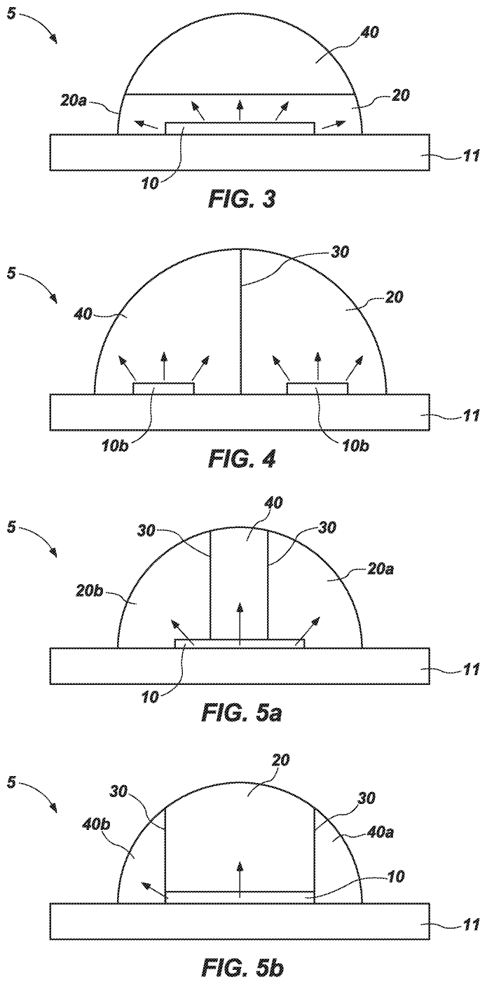

Referring generally to FIGS. 3 through 5b, in another aspect of the technology, one or more lighting emitting elements 10 are disposed on a substrate 11. A phosphor layer 20 is disposed about at least a portion of one or more lighting elements 10. A photoluminescent layer 40 is also disposed about one or more portions of lighting element 10. With respect to FIG. 3, a phosphor layer 20 is disposed about and fully encapsulates light emitting element 10. A photoluminescent layer 40 is disposed above the phosphor layer 20. In this aspect, the photoluminescent layer covers the entire top layer of the phosphor layer, however, due to the geometry of the phosphor layer 20, a side portion 20a of the phosphor layer 20 does not have a photoluminescent layer 40 placed directly above it. In this manner, portions of light propagated from element 10 pass through both the phosphor layer 20 and the photoluminescent layer 40 and portions of light propagated from element 10 pass only through phosphor layer 20, namely that portion passing through sidewall 20a.

FIG. 4 discloses another aspect where more than one light emitting element 10 is disposed on a single substrate 11 and are electrically coupled together. However, each light emitting element 10 is encapsulated in a different layer. Namely, in the specific example shown on FIG. 4, one light emitting element 10a is encapsulated in a phosphor layer 20 and one light emitting element 10b is encapsulated in a photoluminescent layer 40. In this aspect, the two different layers (20, 40) may be separated by an opaque fixture 30 comprising film, paper, or other thin material. However, the different layers (20, 40) need not be separated by a fixture 30 or may be separated by a transparent fixture so that light emitted from either element (10a or 10b) may pass through the different layers. It is also understood that the technology described herein may be applied to a plurality of lighting elements, rather than first and second light emitting elements (10a, 10b). Meaning, a first plurality of light emitting elements may be separated from a second plurality of light emitting elements by a fixture 30. There may be some overlap in the different layers (20, 40) between light emissions from the different pluralities of the light emitting elements depending on how the fixture 30 is positioned on the lighting device 5. In another aspect of the technology, different light emitting elements disposed about different portions of the lighting device 5 may be selectively turned on and off, alternating portions of the device where light is emitted through layer 20, layer 40, or both layers simultaneously.

FIGS. 5a and 5b disclose another aspect where a light emitting element 10 is encapsulated by both a phosphor layer 20 and photoluminescent layer. In 5a, for example, the phosphor layer 20 is disposed on left and right sides of element 10 and the photoluminescent layer 40 is located between the phosphor layer 20a on the one side and phosphor layer 20b on the other. In 5b, the phosphor layer 20 is located between a photoluminescent layer 40a on one side and a photoluminescent layer 40b on the other.

As with the aspect shown in FIG. 4, the different layers may be separated by a fixture 30 (opaque or transparent) or no fixture at all. In another aspect, the fixture 30 may only extend partway between the two different layers such that a portion of the light emissions between the two layers are blocked by the fixture 30 (opaque or transparent) and another portion is not blocked. In the aspect where there is no fixture, the two layers abut one another and form a boundary between adjacent layers. It is understood that the different layers may be organized and placed in a number of different orientations so long as a portion of light from the same device 5 passes through both the phosphor layer 20 and the photoluminescent layer 40.

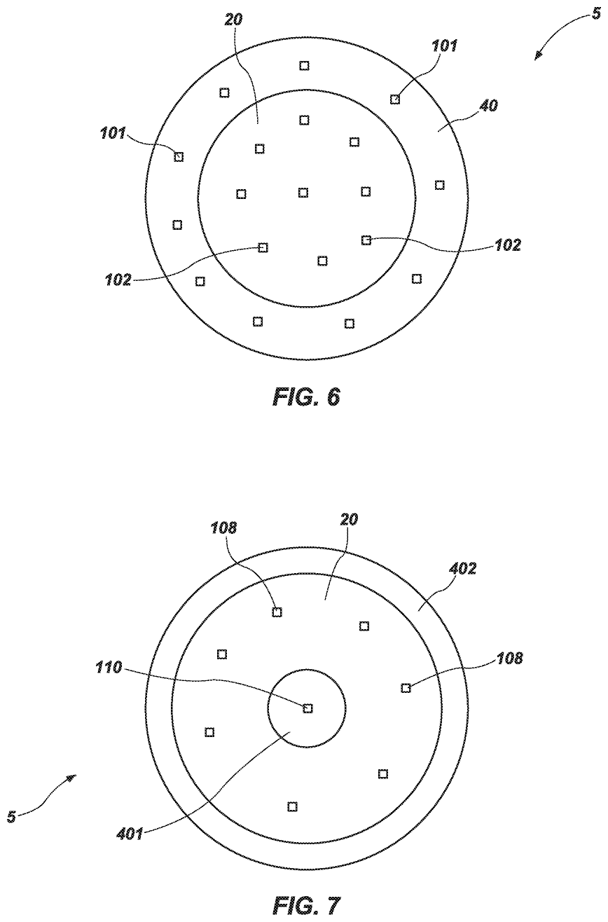

FIGS. 6 through 9 are top views of additional lighting devices 5 in accordance with aspects of the technology. FIG. 6, for example, discloses a light device 5 comprising a first section of light emitting elements 101 encapsulated in a photoluminescent layer 40. A second section of light emitting elements 102 are disposed within an interior perimeter of the first section of light emitting elements 101. The second section of light emitting elements 102 is encapsulated by a phosphor layer 20.

The second section of light emitting elements 102 may also be encapsulated by the photoluminescent layer 40 and vice versa. In one aspect, the light emitting elements 101 are configured to emit light in the UVA, UVB, and/or UVC spectrums (i.e., about 100 nm to about 400 nm).

FIG. 7 discloses a first section of light emitting elements 108 encapsulated in a phosphor layer 20 and a second section of light emitting elements 110 within an interior perimeter of the first section. The second section is encapsulated by a photoluminescent layer 401. An additional photoluminescent layer 402 is disposed about an outer perimeter of the first section and is oriented such that a portion of light propagated from the first section of light emitting elements 108 passes through the photoluminescent layer 402. A portion of light from elements 108 may pass through all layers (20, 401, and 402) or it may be partitioned by a fixture preventing all, or a portion, of light from passing between layers.

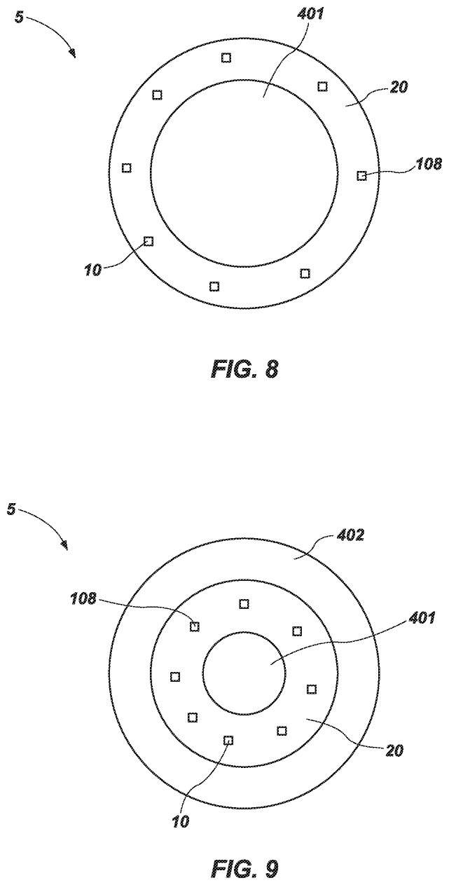

FIG. 8 discloses a section of light emitting elements 108 encapsulated by a phosphor layer 20. A photoluminescent layer 401 is located adjacent the phosphor layer 20 and within an interior perimeter of the section of light emitting elements 108 such that a portion of light propagated from light emitting elements 108 passes through the layer 401. FIG. 9 discloses a device 5 having a section of light emitting elements 108 encapsulated by a phosphor layer 20. A first photoluminescent layer 401 is disposed within an interior perimeter of the section of light emitting elements 108 and a second photoluminescent layer 402 is disposed about an exterior perimeter of the phosphor layer 20. Several examples of different arrangements are disclosed. However, it is understood that different component parts from the different examples shown herein may be used in different devices. For example, the arrangement shown in FIG. 8 may be combined with the arrangement shown in FIG. 5b such that different aspects of each, but not all aspects of each, are used in a lighting device 5. Moreover, different fixtures may be used to modify light transmission between different layers so that all light is transferred between layers, no light is transferred between layers, or portions of light are transferred between different layers.

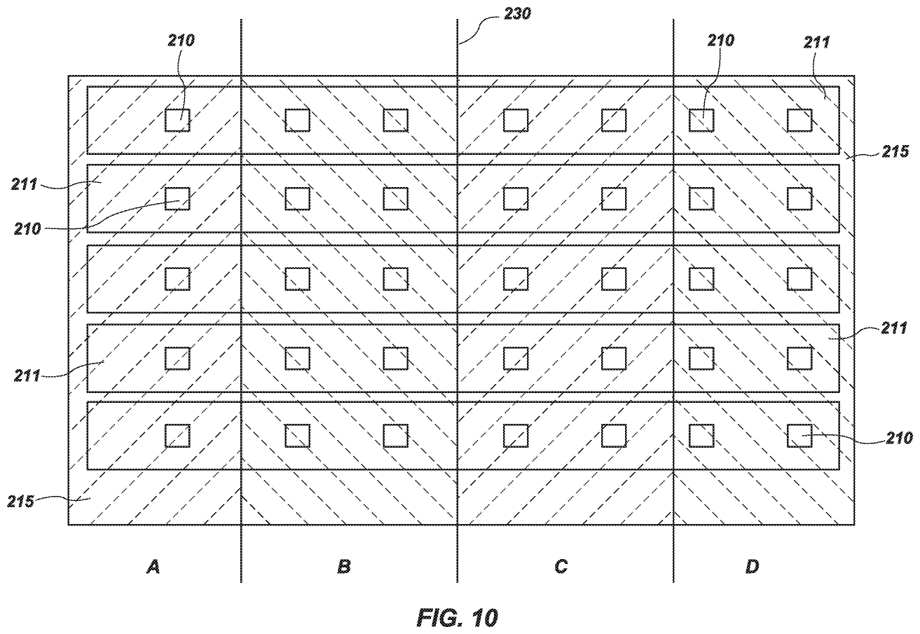

FIG. 10 discloses fixture 215 that may be used to manufacture different lighting devices in accordance with aspects of the technology. Fixture 215 comprises a plurality of substrates 211 that may be removed from the fixture 215. Each substrate comprises a plurality of light emitting elements 210 that are electrically coupled. This fixture may be made of one piece, or fixed in nature, or comprised of individual sections, each designed to hold one of the lighting elements 210, allowing them to be varied to facilitate different lighting elements 210, or different assembly processes. In one aspect, a manufacturer may divide the fixture 15 into different zones A, B, C, and D. Each zone may be divided by a fixture 230 or no fixture at all. Zone A and C may be treated with a phosphor layer 220 while Zone B and D are treated with a photoluminescent layer 240. Fixture 215 may incorporate some of the equipment needed to deposit layer 220 and/or layer 240 in liquid film, or other forms, as part of a larger automated process. Fixture 230 may also be integrated into fixture 215, either permanently, or as a removable component, to facilitate automated processes. Multiple additional layers may be applied in subsequent processes. Layers may be applied via manual or automated processes, in liquid, film, dry powder or particle, chemical vapor deposition, or other deposition methods. Once each of the respective layers have cured, the substrates 211 are removed from the fixture 215, either manually or through the use of automated equipment. The method allows for production of multiple substrates 211 with different layers (220, 240) in a single application. Fixture 215 and 230, if used, may also incorporate features to facilitate electrical or optical testing of the unfinished or finished substrate to determine electrical or optical performance and/or quality.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the invention should be determined solely by the appended claims and their legal equivalents, rather than by the descriptions and examples given above.

1. A hand held light having a light assembly, the light assembly comprising:
a substrate carrying a light emitting element, said light emitting element coupled to a power source;
a phosphor layer disposed atop the substrate and light emitting element, encapsulating the lighting emitting element such that all light emitted from the light emitting element passes through, or is attenuated by the phosphor layer, wherein the phosphor layer comprises a luminescent formulation configured to convert light emitted from the light emitting element to white light; and
a photoluminescent layer disposed about the phosphor layer such that light emitted from the light emitting element that passes through the phosphor layer passes through or is attenuated by the photoluminescent layer, wherein the photoluminescent layer comprises a photoluminescent formulation.

2. The light assembly of claim 1, wherein the light emitting element comprises a light emitting diode.

3. The light assembly of claim 1, wherein the phosphor layer comprises a mixture of phosphor powder and a transparent medium.

4. The light assembly of claim 3, wherein the photoluminescent layer comprises a mixture of a phosphor powder and a transparent medium, the phosphor powder mixture for the photoluminescent layer being different that the phosphor powder mixture for the phosphor layer.

5. The light assembly of claim 1, wherein the photoluminescent layer comprises a film.

6. The light assembly of claim 1, wherein the substrate carrying the light element comprises a planar annular substrate.

7. A hand held light having a light assembly, the light assembly comprising:
a substrate carrying a plurality of light emitting element, said light emitting elements coupled to a power source;
a phosphor layer disposed about the substrate and a first portion of the plurality of light emitting elements, encapsulating the first portion of the plurality of lighting emitting elements such that all light emitted from the first portion of the plurality of light emitting element passes through, or is attenuated by the phosphor layer, wherein the phosphor layer comprises a luminescent formulation configured to convert light emitted from the first portion of light emitting elements to white light; and
a photoluminescent layer disposed about a second portion of the plurality of light emitting elements such that all light emitted from the second portion of the plurality of light emitting elements passes through or is attenuated by the photoluminescent layer.

8. The light assembly of claim 7, wherein the first portion of the plurality of light emitting elements and the second portion of the plurality of light emitting element share light emitting elements.

9. The light assembly of claim 7, wherein light emitted from the first portion of the plurality of light emitting elements passes through the phosphor layer and the photoluminescent layer.

10. The light assembly of claim 7, wherein light emitted from the second portion of the plurality of light emitting elements does not pass through the phosphor layer.

11. The light assembly of claim 7, wherein light emitted from the first portion of the plurality of light emitting elements does not pass through the photoluminescent layer.

12. The light assembly from claim 7, wherein a first portion of light emitted from the first portion of the plurality of light emitting elements passes through the phosphor layer and the photoluminescent layer and a second portion of light emitted from the first portion of the plurality of light emitting elements passes only through the phosphor layer.

13. The light assembly from claim 7, wherein a first portion of light emitted from the second portion of the plurality of light emitting elements passes through the phosphor layer and the photoluminescent layer and a second portion of light emitted from the second portion of the plurality of light emitting elements passes only through the photoluminescent layer.

14. The light assembly of claim 7, wherein the photoluminescent layer comprises a photoluminescent formulation comprising yttrium aluminum garnet and strontium aluminate.

15. The light assembly of claim 7, wherein the photoluminescent layer comprises a photoluminescent formulation comprising cerium lithium aluminum oxide.

16. A method of propagating light through a light assembly, comprising:
providing power to a light emitting element disposed about a substrate, resulting in the propagation of a wavelength of light from the light emitting element;
propagating the wavelength of light through a phosphor layer, converting the wavelength of light into white light;
propagating a portion of the converted wavelength of light through a photoluminescent layer disposed adjacent the phosphor layer.
exciting photoluminescent material within the photoluminescent layer from the photoluminescent layer; and
propagating photoluminescent light from the photoluminescent layer.

17. The method of claim 16, further comprising using a fixture to block propagation of a portion of light emanating from the phosphor layer from entering the photoluminescent layer.

18. The method of claim 16, further comprising providing power to a first portion of a plurality of light emitting elements disposed about the substrate and providing power to a second portion of the plurality of light elements disposed about the substrate, the first and second portions of the plurality of light emitting elements being encapsulated by the phosphor layer and the second portion of the plurality of light emitting elements configured to propagate light through the phosphor layer and the photoluminescent layer.

19. The method of claim 18, wherein the first portion of the plurality of light emitting diodes propagate light through the phosphor layer and the photoluminescent layer.

20. The method of claim 18, further comprising propagating a wavelength of light ranging from about 100 nm to about 400 nm into the photoluminescent layer.

21. A lighting assembly, comprising:
a substrate carrying a plurality of light emitting element, said light emitting elements coupled to a power source;
a photoluminescent layer disposed about the substrate wherein the photoluminescent layer comprises a luminescent formulation configured to convert light emitted from the light emitting elements to white light; and
wherein the a photoluminescent layer comprises a photoluminescent formulation having a fluorescent material or a phosphorescent material therein.
